(19) United States
(12) Patent Application Publication
(10) Pub. No.: US 2024/0334923 A1
(43) Pub. Date: Oct. 10, 2024

(54) TREE STAND

(71) Applicant: Jack DESHON, Savannah, MO (US)

(72) Inventor: Jack DESHON, Savannah, MO (US)

(21) Appl. No.: 18/132,357

(22) Filed: Apr. 7, 2023

(51) Int. Cl. A01M 31/02

(52) U.S. Cl. CPC A01M 31/02

(57) ABSTRACT

Disclosed is a tree stand that includes a platform, a low-profile arm that is pivotable, and a chair rotatably mounted to the low-profile arm that rotates 360 degrees. The tree stand enables the hunter to easily traverse the low-profile arm when rotating the rotatable chair and allows the hunter to achieve an unobstructed 360 degree rotation of the chair about its axis of rotation to better view the game approaching in all directions.

### TECHNICAL FIELD

The present disclosure relates to a stand for use with a tree or pole. The present disclosure more particularly relates to a stand for use with a tree or pole that provides both a pivotable arm and rotatable chair to allow for unobstructed pivotable and 360 degree rotatable reorientation of the user from the seated position and to provide a 360 degree view from a seated position.

### BACKGROUND

Hunting is a human activity typically carried out to obtain food, eliminate predators that are dangerous to humans or other animals, eliminate pests and nuisance animals that endanger agricultural crops and livestock, to minimize the spread of certain diseases, for ecological/environmental conservation, and for recreation.

Tree stands are a popular with hunters and are typically used to hunt deer and other small-, medium-, and large-sized game. There are a wide variety of different tree stands that a hunter may select including, for example, hang-on stands, climbing stands, ladder stands, and tripod stands.

Ladder tree stands are very popular among hunters and have proven to be very successful in hunting game in wooded areas. Most ladder tree stands include a platform that carries a chair, bench, or stool-style seat that is attached to the platform. The platform is elevated and secured to a tree with a suitable securement means. A vertically extending ladder is connected to the elevated platform and is used by the hunter to climb up to the elevated platform. For ladder tree stands that utilize a chair seat having a seat-back portion, the seat-back of the chair seat is usually fastened adjacent to a tree trunk and the hunter rests his feet on the surface of the platform. For ladder tree stands that utilize bench or stool-style seats, the hunter leans his back against the tree trunk and the platform is utilized to rest the hunter's feet during the hunt.

While the elevated tree stands provide an elevated vantage point to observe game while hunting, most tree stands do not provide the bunter a 360 degree view from a seated position. Most tree stands have the chair engaged with the tree trunk and facing away from the tree. This provides the hunter with a 180 degree view facing away from the tree, but the hunter will not be able to see behind them without standing up from the chair. If the hunter wants to see what's behind, or look to the left or right, the hunter will need to stand up and look behind or to the left and right. Standing up from the tree stand chair and moving about the platform while hunting is disadvantageous, because the movements often create noise that startle the game being hunted and present a fall risk for the hunter.

While certain tree stands that incorporate a rotatable chair are known, the rotatable chair is still positioned in-line with the tree and the tree obstructs a complete 360 degree view for the hunter. The inventor hereby discloses a tree stand for hunting that enables the hunter to move the chair seat from a first position that is obstructed to a different position that is not obstructed while at the same time enable a 360 degree unobstructed rotation of the chair seat itself to allow the hunter to maintain a forward orientation to the game animal and an unobstructed 360 degree view from a seated position.

### SUMMARY

According to illustrative embodiments, disclosed is a tree stand comprising a platform, a low-profile arm pivotally mounted to said platform, and a rotatable chair rotatably mounted to said low-profile arm, wherein the low-profile arm pivots from a neutral position and allows the chair to move from side-to-side and rotate 360 degrees.

### BRIEF DESCRIPTION OF THE DRAWINGS

FIG. 1 is a front view of an illustrative embodiment of the tree stand.

FIG. 2A is a side view of the illustrative embodiment of the tree stand of FIG. 1.

FIG. 2B is a side view of another illustrative embodiment of the tree stand.

FIG. 3A is a side view of an illustrative embodiment of a stool-style seat for use with the tree stand.

FIG. 3B is a side view of another illustrative embodiment the chair seat of the tree stand.

FIG. 4 is a top plan view of tree stand of FIG. 1 without chair or low-profile arm.

FIG. 5A is a top perspective view of mounting base member of tree stand.

FIG. 5B is a front view of mounting base member of tree stand.

FIG. 6A is a top plan view of an illustrative embodiment of the tree stand with the chair in the neutral position N.

FIG. 6B is a top plan view of an illustrative embodiment of the tree stand showing the range of motion of the pivotable low-profile arm and 360° rotation of chair relative to the neutral position N.

FIG. 7 is a top plan view of another illustrative embodiment of the tree stand with the chair in the neutral position N.

### DETAILED DESCRIPTION

Throughout the present disclosure, the use of the articles “a,” “an,” and “the” refer to one or to more than one (that is, at least one) of the grammatical object of the article.

Throughout the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount, or quantity of any component in an embodiment can be determined by varying the value, determining the effectiveness of the compositions or methods for each value, and determining the range of values that produce compositions or methods with the desired degree of effectiveness in accordance with the present disclosure.

It should be understood that when a range of values is described in the present disclosure, it is intended that any and every value within the range, including the end points, is to be considered as having been disclosed. For example, “a range of from greater than 0 degrees to about 270 degrees” is to be read as indicating each and every possible number along the continuum between greater than 0 and 270. It is to be understood that the inventors appreciate and understand that any and all values within the range are to be considered to have been specified, and that the inventors have possession of the entire range and all the values within the range.

Disclosed is a tree stand for hunters. The tree stand comprises a platform, a pivotable low-profile arm pivotally mounted to the platform, and a rotatable chair rotatably mounted to the low-profile arm. The combination of the pivotable low-profile arm and the rotatable chair is configured to enable the hunter to move the position of the chair and to enable unobstructed 360 degree rotation of the chair seat about its axis of rotation, to maintain a forward facing orientation relative to the game being hunted, and to achieve a 360 degree view around a tree to detect or otherwise observe game approaching from all directions.

The tree stand includes a platform. According to certain embodiments, the entire platform is substantially planar and includes opposite facing first and second surfaces. According to certain embodiments, the entire platform is planar and includes opposite facing first and second surfaces. The outer perimeter of the platform of the tree stand is defined by frame. According to certain embodiments, the platform of the tree stand comprises a half-octagon shape in top plan view. It should be noted however, that the half-octagon shape is only one illustrative geometric shape for the platform. The platform may comprise any one of a wide variety of geometric shapes including, but not limited to, circle, pentagon, hexagon, octagon, nonagon, oval, rectangle, rhombus, square, trapezoid, or triangular in top plan view.

As used throughout the specification, the term “low-profile arm” refers to a member that pivotally connects the chair of the tree stand to the platform of the tree stand, and which is positioned above the upper surface of the platform by a distance needed to permit the arm to pivot without interference from the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 12 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 9 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 6 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 5 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 4 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 3 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 2 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 1 inch above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 0.75 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 0.5 inches above the upper surface of the platform of the tree stand.

According to certain illustrative embodiments, the “low-profile arm” refers to an arm having a portion that extends substantially horizontally relative to the upper surface of the platform of the tree stand, that is positioned above the upper surface of the platform by a distance needed to permit the arm to pivot without interference from the upper surface of the platform of the tree stand, and where the upper margin, point, or surface of the horizontally extending portion of the low-profile arm is positioned no greater than 0.25 inches above the upper surface of the platform of the tree stand.

The low-profile arm of the tree stand is capable of pivoting in an arc in the range of greater than 0 degrees to about 270 degrees. The low-profile arm is configured for pivotable movement in a horizontal plane across the entire range of greater than 0 to 270 degrees.

The low-profile arm of the tree stand is capable of pivoting in an arc in the range of greater than 0 degrees to about 180 degrees.

According to certain illustrative embodiments, low-profile arm pivots in an arc in a range of about 30 degrees.

According to certain illustrative embodiments, low-profile arm pivots in an arc in a range of about 60 degrees.

According to certain illustrative embodiments, low-profile arm pivots in an arc in a range of about 90 degrees.

According to certain illustrative embodiments, low-profile arm pivots in an arc in a range of about 120 degrees.

According to certain illustrative embodiments, low-profile arm pivots in an arc in a range of about 150 degrees.

According to certain illustrative embodiments, low-profile arm pivots in an arc in a range of about 180 degrees.

According to certain illustrative embodiments, the bottom margin or surface of the low-profile arm is positioned above the upper surface of the platform to the extent needed to permit the low-profile arm to freely pivot in an arc in the range of from greater than 0 degrees to about 270 degrees without any interference from the platform. The design and position of the low-profile arm minimizes the height to which the hunter must lift or otherwise raise his or her feet off the platform to traverse the low-profile arm when rotating the rotatable chair from the seated position. The low-profile arm thus enables the hunter to achieve an unobstructed 360 degree rotation of the chair and, as a result, an unobstructed 360 degree rotation of the hunter while sitting on the chair, without interference of the hunter's feet or legs from the low-profile arm that connects the chair to the platform.

Any type of seat that is configured to support a hunter on the platform of the tree stand may be utilized in the tree stand. For example, and not in limitation, suitable chairs include chair seats having a seat portion and a seat-back portion, bench-style seats, stool-style seats, and the like. According to certain embodiments, the chair of the tree stand comprises a seat portion having a front edge, a rear edge, and side edges that together define the outer perimeter of the seat. The chair further comprises a seat back portion engaged with the rear edge of the seat portion of the chair and extends vertically upwardly from the rear edge of the seat of the chair. According to certain illustrative embodiments, the chair may also include arm rests positioned on one or both lateral sides of the chair. According to certain illustrative embodiments, the front edge of the seat of the chair is mounted to an end of the low-profile arm. The chair is rotatably mounted on the low-profile arm and rotates 360 degrees about an axis of rotation.

The low-profile arm comprises a first arm portion having first and second ends. The chair of the tree stand is rotatably mounted to the first end of the first arm portion of low-profile arm and the first arm portion extends vertically downwardly from the seat of the chair toward the upper surface of the platform. The low-profile arm includes a second arm portion having first and second ends and the first end of the second arm portion is connected to the second end of the first arm portion to form a first obtuse angle that faces toward the rear of the seat of the chair. The low-profile arm includes a third arm portion having first and second ends and the first end of the third arm portion of the low-profile arm is connected to the second end of the second arm portion of the low-profile arm to form a second obtuse angle facing toward the rear of the seat of the chair. The third arm portion of the low-profile arm extends substantially horizontally relative to the upper surface of the platform to enable easy clearance of the hunter's feet over the low-profile arm the while the hunter is pivoting the low-profile arm and/or rotating the chair of the tree stand from the seated position.

According to other embodiments, the low-profile arm comprises a first arm portion having first and second ends, wherein the chair is rotatably mounted to the first end of the first arm portion of low-profile arm and the first arm portion extends downwardly from the seat of the chair at an angle of greater than 0 degrees and less than 90 degrees from an imaginary line extending vertically downwardly from the seat of the chair. The low-profile arm further comprises a second arm portion having first and second ends, wherein the first end of the second arm portion is connected to the second end of the first arm portion to form a first obtuse angle facing toward the rear of the seat of the chair, and wherein the second arm portion of the low-profile arm extends horizontally relative to the top surface of the platform.

According to other embodiments, the low-profile arm comprises a first arm portion having first and second ends, wherein the chair is rotatably mounted to the first end of the first arm portion of the low-profile arm and the first arm portion extending vertically downwardly from the seat of the chair. The low-profile arm further comprises a second arm portion having first and second ends, wherein the first end of the second arm portion is connected to the second end of the first arm portion to form a right angle facing toward the rear of the seat of the chair, and wherein the second arm portion of the low-profile arm extends horizontally relative to the top surface of the platform.

According to certain embodiments, the tree stand further comprises a base member that is integral with the platform for pivotally mounting the low-profile arm of the tree stand. According to other embodiments, the tree stand further comprises a base member that is attached, affixed, or otherwise or connected to the platform for pivotally mounting the low-profile arm of the tree stand. According to certain embodiments, the base member carries a plurality of serrations or teeth formed in the base member for gripping a tree trunk. According to other embodiments, the base member for pivotally mounting the low-profile arm to the platform does not include serrations or teeth. According to these embodiments, additional members having serrations or teeth are separately added to the frame of the platform to enable gripping contact with the tree.

The tree stand may be engaged with a tree or other vertically extending pole by the base mounting member and an engagement means that is configured to be engaged with the base member for securing the tree stand to the tree trunk or pole. Without limitation, and only by way of illustration, the engagement means may be selected from the group consisting of a belt, a band, a chain, a harness, a rope, a strap, a ratchet strap, a tie, and a wire. According to certain embodiments, the engagement means comprises an elongated strap having a length sufficient to encircle a tree trunk. The elongated band has opposite first and second ends that terminate with means for attaching the elongated band to the base member of the tree stand. Without limitation, and only by way of illustration, the means for attaching the elongated strap to the base mounting member may be selected from clasps, clips, hooks, clevis hooks, cup hooks, eye hooks, latching hooks, J-hooks, snapping hooks, S-hooks, swivel hooks, and the like.

The tree stand further comprises a ladder attached to, or engaged with, the platform of the tree stand. The ladder comprises spaced-apart two elongated side rails and a plurality of rungs extending horizontally between the elongated side rails. The ladder has opposite first and second ends. The first opposite end of the ladder is positioned on the ground below the platform and the second opposite end of the ladder is attached to or engaged with the front edge of the platform of the tree stand. The tree stand includes brace members positioned on each lateral side of the platform of the tree stand. The brace members are attached to the platform of the tree stand and the spaced-apart two elongated side rails of the ladder. According to certain embodiments, the brace members are attached to the second surface of the platform and extend from the rear underside of the platform diagonally to the spaced-apart two elongated side rails of the ladder.

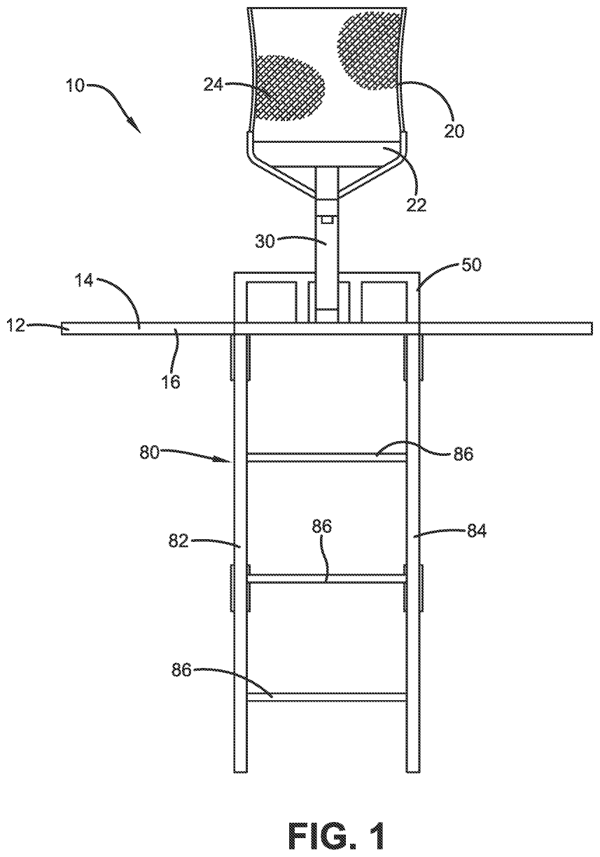

FIG. 1 shows a front view of an illustrative embodiment of the tree stand 10. Tree stand 10 includes platform 12. Platform 12 includes opposite facing first (upper) 14 surface and second (lower) surface 16. Chair 20 is pivotally mounted to platform 12 by low-profile arm 30 and mounting base member 50. Chair 20 has a seat portion 22 and seat-back portion 24 extending vertically upwardly from the seat portion 22 of the chair 20. Tree stand 10 includes ladder 80 that is engaged with the second (lower) surface 16 of the platform 12. Ladder 80 includes spaced-apart vertically extending rails 82, 84 and a plurality of rungs 86 extending horizontally between the spaced-apart rails 82, 84.

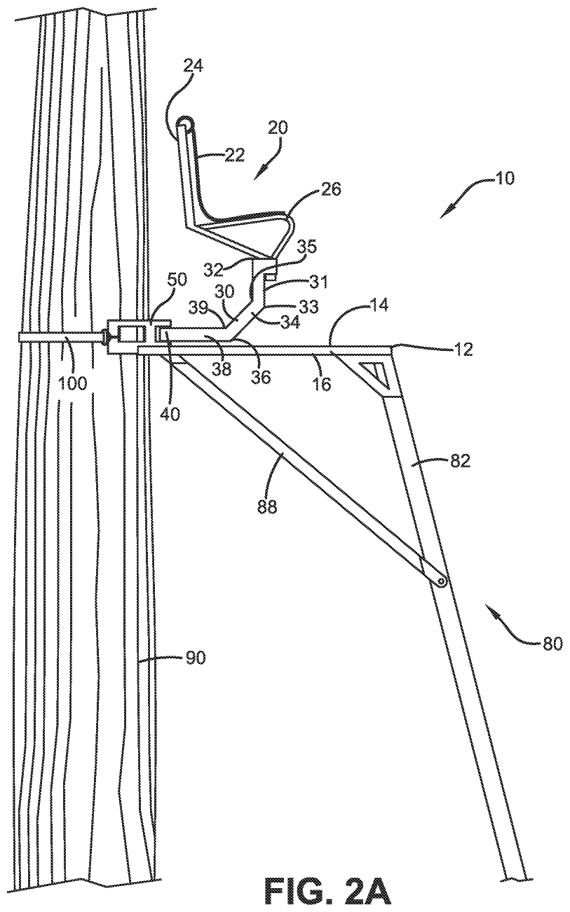

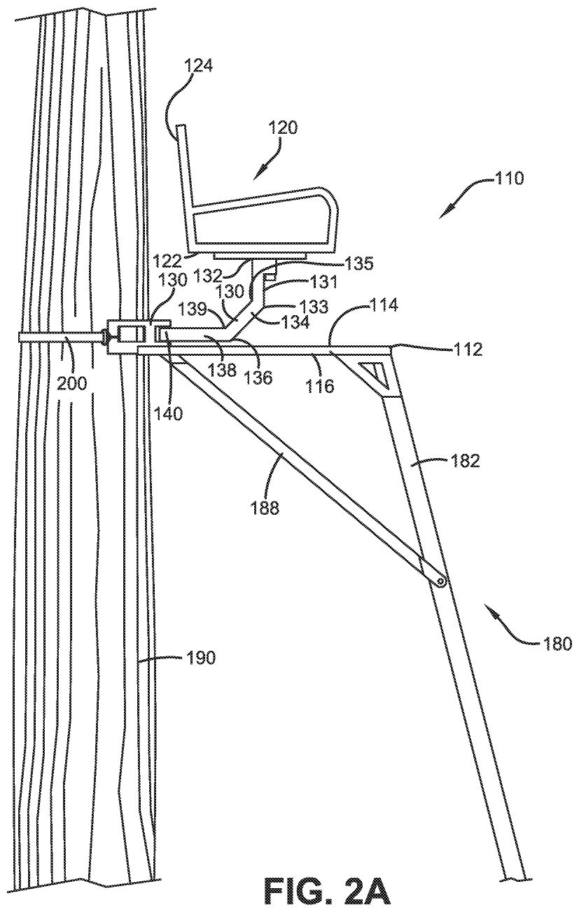

FIG. 2A shows a side view of tree stand 10. Tree stand 10 includes platform 12. Platform 12 includes opposite facing first (upper) 14 surface and second (lower) surface 16. Platform 12 includes a front edge 13 and a rear edge 15 having a portion that is in adjacent contact with tree 90. Chair 20 is pivotally mounted to platform 12 by low-profile arm 30 and mounting base member 50. Chair 20 has a seat surface 22 and a support 24 for supporting the seat surface 22 from below. Chair 20 further includes outer supports 26 that further support both marginal sides of seat surface 22 from below. Support 24 mounts chair 20 to the upper end of the low-profile arm of the tree stand. Tree stand 10 includes ladder 80 that is engaged with the second (lower) surface 16 of the platform 12. Brace member 88 is attached to the second (lower) 16 surface of platform 12 and rail 82 of ladder 80 and extends is a substantially diagonally fashion between the second surface 16 of platform 12 and rail 82 of ladder 80.

Still referring to FIG. 2A, low-profile arm 30 may include first arm portion 31 having opposite first 32 and second 33 first arm portion ends. Chair 20 is rotatably attached to first arm portion end 32 of first arm portion 31. The first arm portion 31 extends vertically downwardly from the chair 20 toward the upper surface 14 of the platform 12. The low-profile arm 30 includes a second arm portion 34 having first 35 and second 36 ends and the first end 35 of the second arm portion 34 is connected to the second end 33 of the first arm portion 31 to form a first obtuse angle 37 that faces toward the rear of the seat 22 of the chair 20. The low-profile arm 30 includes a third arm portion 38 having first 39 and second 40 ends and the first end 39 of the third arm portion 38 of the low-profile arm 30 is connected to the second end 36 of the second arm portion 34 of the low-profile arm 30 to form a second obtuse angle 41 facing toward the rear of the seat surface 22 of the chair 20. The third arm portion 38 of the low-profile arm 30 extends substantially horizontally relative to the upper surface 14 of the platform 12 to enable easy clearance of the hunter's feet over the low-profile arm 30 the while the hunter is pivoting the low-profile arm 30 and/or rotating the chair 20 of the tree stand 10 from a seated position. Second end 40 of the third arm portion 38 of the low-profile arm 30 is pivotally mounted to the platform 12 with mounting base member 50. Tree stand 10 is engaged with tree 90 with elongated strap 100.

FIG. 2B shows a side view of another embodiment of the tree stand 110. Tree stand 110 includes platform 112. Platform 112 includes opposite facing first (upper) 114 surface and second (lower) surface 116. Platform 112 includes a front edge 113 and a rear edge 115 having a portion that is in adjacent contact with tree 190. Chair 120 is pivotally mounted to platform 112 by low-profile arm 130 and mounting base member 150. Chair 120 has a seat surface 122 and a seat back 124. Chair 120 to the upper end of the low-profile arm 130 of the tree stand. Tree stand 110 includes ladder 180 that is engaged with the second (lower) surface 116 of the platform 112. Brace member 188 is attached to the second (lower) 116 surface of platform 112 and rail 182 of ladder 180 and extends is a substantially diagonally fashion between the second surface 116 of platform 112 and rail 182 of ladder 180.

Still referring to FIG. 2B, low-profile arm 130 may include first arm portion 131 having opposite first 132 and second 133 first arm portion ends. Chair 120 is rotatably attached to first arm portion end 132 of first arm portion 131. The first arm portion 131 extends vertically downwardly from the chair 120 toward the upper surface 114 of the platform 112. The low-profile arm 130 includes a second arm portion 134 having first 135 and second 136 ends and the first end 135 of the second arm portion 134 is connected to the second end 133 of the first arm portion 131 to form a first obtuse angle 137 that faces toward the rear of the seat 122 of the chair 120. The low-profile arm 130 includes a third arm portion 138 having first 139 and second 140 ends and the first end 139 of the third arm portion 138 of the low-profile arm 130 is connected to the second end 136 of the second arm portion 134 of the low-profile arm 130 to form a second obtuse angle 141 facing toward the rear of the seat 122 of the chair 120. The third arm portion 138 of the low-profile arm 130 extends substantially horizontally relative to the upper surface 114 of the platform 112 to enable easy clearance of the hunter's feet over the low-profile arm 130 the while the hunter is pivoting the low-profile arm 130 and/or rotating the chair 120 of the tree stand 110. Second end 140 of the third arm portion 138 of the low-profile arm 30 is pivotally mounted to the platform 112 with mounting base member 150. Tree stand 110 is engaged with tree 190 with elongated strap 200.

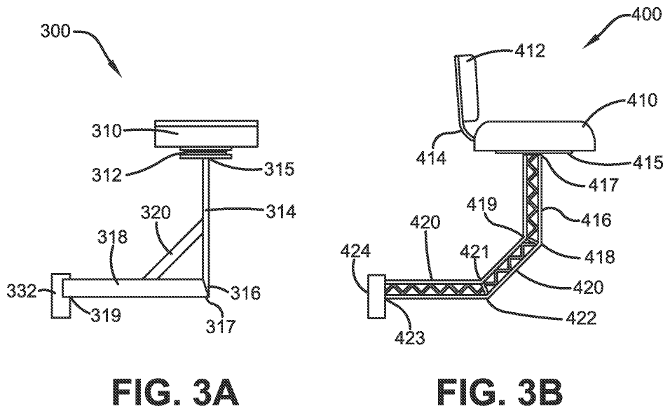

FIG. 3A shows another embodiment of the chair for use with the tree stand. Chair 300 comprises a rotatable stool-style chair. Chair 300 includes a seat surface 310. Seat surface 310 is mounted on rotatable base 312. Rotatable base 312 is rotatably mounted on the upper end 315 of low-profile arm portion 314. Low profile arm portion 314 extends vertically downwardly from rotatable base 310. Lower end 316 of low-profile arm portion 314 is connected to the first end 317 of low-profile arm portion 318. Low-profile arm portion 318 extends horizontally from first end 317 to second end 319. Second end 319 of horizontally extending low-profile arm portion 318 is connected to member 320 for connection the low-profile arm to the platform of the tree stand.

FIG. 3B shows another embodiment of the chair for use with the tree stand. Chair 400 comprises a seat surface 410, a seat-back portion 412 and a connecting member 414 for connecting the seat portion 410 to the seat-back portion 412. Seat surface 410 is mounted on rotatable base 415. Low-profile arm includes first arm portion 416 having opposite first 417 and second 418 first arm portion ends. Rotatable base 415 is rotatably mounted on the upper end 417 of low-profile arm portion 416. The first arm portion 416 extends vertically downwardly from the chair 400 toward the upper surface of the platform. The low-profile arm includes a second arm portion 420 having first 419 and second 421 ends and the first end 419 of the second arm portion 420 is connected to the second end 418 of the first arm portion 416 to form a first obtuse angle that faces toward the rear of the chair 400. The low-profile arm includes a third arm portion 422 having first 423 and second 424 ends and the first end 423 of the third arm portion 422 of the low-profile arm is connected to the second end 421 of the second arm portion 420 of the low-profile arm to form a second obtuse angle facing toward the rear of the chair 400. The third arm portion 422 of the low-profile arm extends substantially horizontally relative to the upper surface of the platform to enable easy clearance of the hunter's feet over the low-profile arm while the hunter is pivoting the low-profile arm and/or rotating the chair of the tree stand. Second end 424 of the third arm portion 422 of the low-profile arm is pivotally mounted to the platform with a mounting base member.

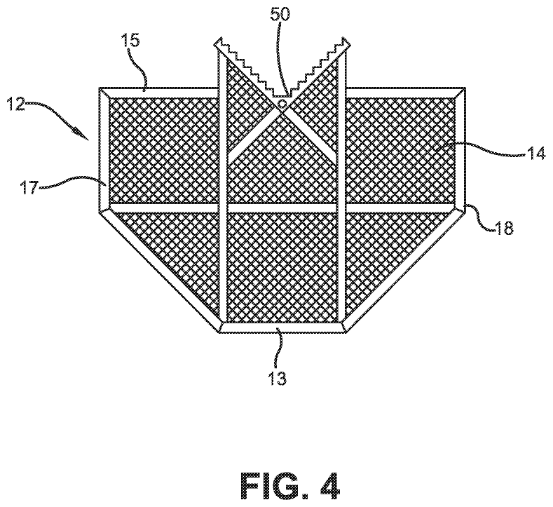

FIG. 4 is a top plan view of tree stand 10 without chair 20 or low-profile arm 30. Platform 12 include first (upper) major surface 14. According to the illustrative embodiment depicted in FIG. 3, platform 12 includes front edge 13, rear edge 15, and sides 17, 18. Mounting base member 50 is mounted on the first surface 14 of platform 12 and extends upwardly from surface 14 of platform 12.

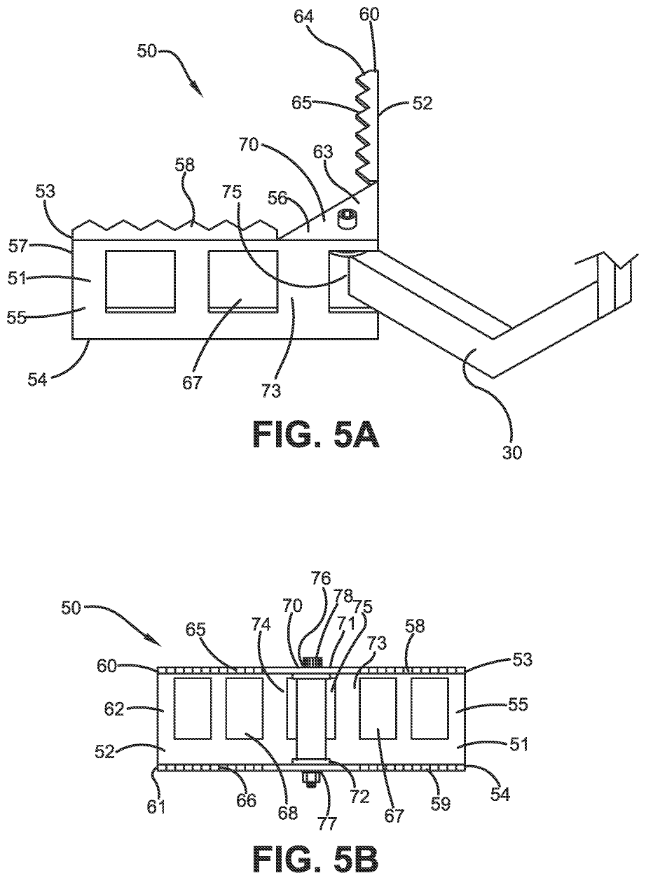

Mounting base member is depicted in FIGS. 5A and 5B. FIG. 5A is a top perspective view of mounting base member 50. FIG. 5B is a front view of mounting base member 50. Mounting base member 50 includes first 51 and second 52 leg portions extending horizontally rearwardly from the rear edge 15 of platform 12 of tree stand 10. First leg portion 51 of mounting base member 50 includes upper edge 53, lower edge 54, side wall 55 extending between the upper edge 53 and lower edge 54, and first 56 and second 57 opposite ends. A first set of a plurality of serrations or teeth 58 extends horizontally from the upper edge 53 of the first leg portion 51 of the base mounting member 50. A second set of a plurality of serrations or teeth 59 extends horizontally from the lower edge 54 of the first leg portion 51 of the base mounting member 50. Second leg portion 52 of mounting base member 50 includes upper edge 60, lower edge 61, side wall 62 extending between the upper edge 60 and lower edge 61, and first 63 and second 64 opposite ends. A first set of a plurality of serrations or teeth 65 extends horizontally from the upper edge 60 of the second leg portion 52 of the base mounting member 50. A second set of a plurality of serrations or teeth 66 extends horizontally from the lower edge 61 of the second leg portion 52 of the base mounting member 50. Side wall 55 of first leg portion 51 of base mounting member 50 includes at least one opening 67 to accommodate a securement means for securing the tree stand 10 to a tree trunk. Side wall 62 of first leg portion 52 of base mounting member 50 includes at least one opening 68 to accommodate a securement means for securing the tree stand 10 to a tree trunk. First 51 and second 52 leg portions of base mounting member 50 extend rearwardly of the rear edge 15 of the platform 12 in a V-shape.

Still referring to FIG. 5A, first end 56 of first leg portion 51 and first end 63 of second leg portion 52 are joined to form low-profile arm mounting region 70. Mounting region 70 includes upper wall 71, lower wall 72, side walls 73, 74 and opening 75. Upper 71 and lower 72 walls of mounting region 70 include orifices 76, 77 aligned along an imaginary vertical axis configured to accept an elongated member 78 for pivotally mounting the low-profile arm 30 to the platform 12 of the tree stand 10. Opening 75 of mounting region 70 is configured with a sufficient height and width to accept second end 40 of the third arm portion 38 of the low-profile arm 30. An elongated member 78 is passed through orifice 76 of upper wall 71, low-profile arm 30, and orifice 77 of the lower wall 72 to pivotally mount low-profile arm 30 to the platform 12. The width of the opening 75 of the mounting region 70 is sufficient to permit pivoting motion of low-profile arm 30 in an arc in the range of greater than 0 to 270 degrees without interference.

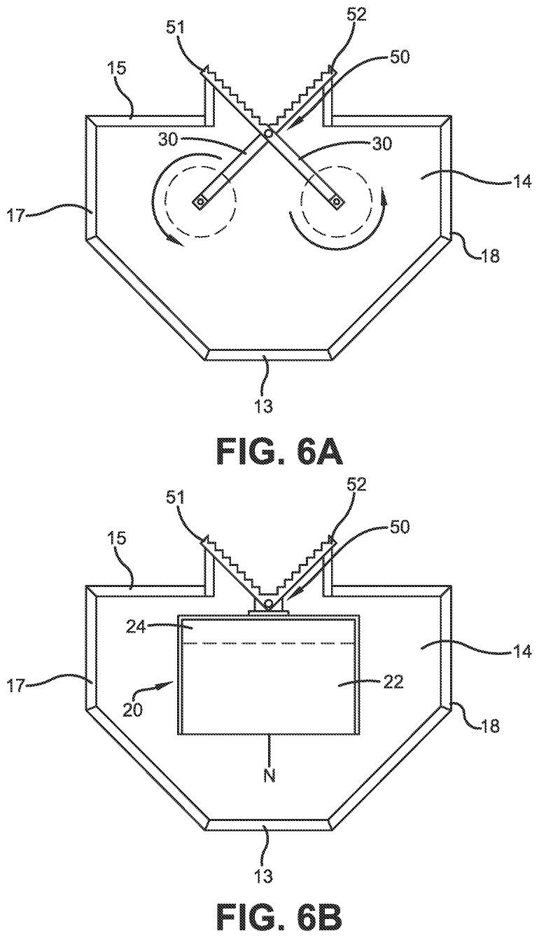

FIGS. 6A and 6B show the range of motion for the pivotable low-profile arm 30 relative to the platform 12 of the tree stand 10. FIG. 6A is a top plan view of an illustrative embodiment of the tree stand 10 showing the range of motion of the pivotable low-profile arm 30 and 360° rotation of chair 20 relative to the neutral position N. FIG. 6B is a top plan view of an illustrative embodiment of the tree stand 10 with the chair 20 in the neutral position N. The neutral position of the chair 20 refers to the position of the chair 20 aligned with the trunk of a tree.

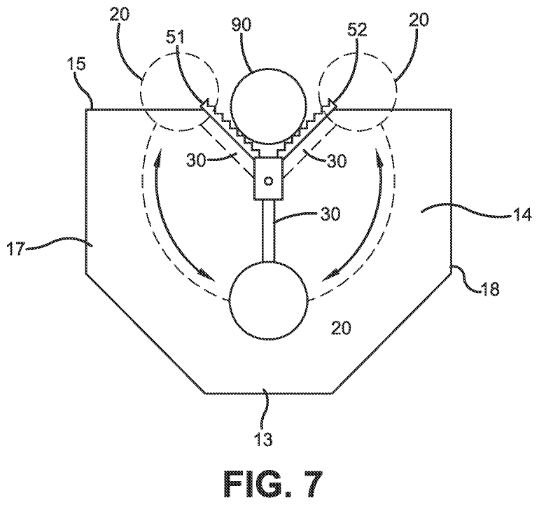

FIG. 7 shows the range of motion for the pivotable low-profile arm 30 relative to the platform 12 of the tree stand 10. FIG. 7 is a top plan view of an illustrative embodiment of the tree stand 10 with the chair 20 in the neutral position N. Platform 12 includes front edge 13, rear edge 15 and side edges 17, 18. The neutral position N of the chair 20 refers to the position of the chair 20 aligned with the trunk of a tree. FIG. 7 shows the 270 degree range of motion of the pivotable low-profile arm 30 and 360° rotation of chair 20 relative to the neutral position N.

While the tree stand has been described above in connection with certain illustrative embodiments, including those embodiments shown in the various drawing figures, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present disclosure should not be limited to any single embodiment, but rather construed in breadth and scope in accordance with the recitation of the attached claims.

1. A tree stand comprising:
a platform;
a low-profile arm pivotally mounted to said platform; and
a rotatable chair rotatably mounted to said low-profile arm;
wherein the low-profile arm pivots from a neutral position and allows the chair to move from side-to-side.

2. The tree stand of claim 1, wherein said low-profile arm pivots in an arc in a range of 30 degrees.

3. The tree stand of claim 2, wherein said low-profile arm pivots in an arc in a range of 60 degrees.

4. The tree stand of claim 3, wherein said low-profile arm pivots in an arc in a range of 90 degrees.

5. The tree stand of claim 4, wherein said low-profile arm pivots in an arc in a range of 120 degrees.

6. The tree stand of claim 5, wherein said low-profile arm pivots in an arc in a range of 150 degrees.

7. The tree stand of claim 6, wherein said low-profile arm pivots in an arc in a range of 180 degrees.

8. The tree stand of claim 1, wherein the chair rotates 360 degrees.

9. The tree stand of claim 7, wherein the chair rotates 360 degrees.

10. The tree stand of claim 1, wherein the chair comprises a seat portion having a front edge and a rear edge and a seat back portion engaged with the rear edge of the seat portion.

11. The tree stand of claim 10, wherein the front edge of the seat of the chair is mounted to the upper portion of the low-profile arm.

12. The tree stand of claim 11, wherein the low-profile arm comprises (a) a first arm portion having first and second ends, wherein the chair is rotatably mounted to the first end of the first arm portion of low-profile arm and the first arm portion extends vertically downwardly from the seat of the chair, (b) a second arm portion having first and second ends and wherein the first end of the second arm portion is connected to the second end of the first arm portion to form a first obtuse angle facing toward the rear of the seat of the chair, and (c) a third arm portion having first and second ends, wherein the first end of the third portion of the low-profile arm is connected to the second end of the second portion of the low-profile arm to form a second obtuse angle facing toward the rear of the seat of the chair, and the third arm portion of the low-profile arm extends horizontally relative to the top surface of the platform.

13. The tree stand of claim 1, wherein said platform comprises a frame defining a perimeter and a planar surface.

14. The tree stand of claim 13, wherein said platform comprises a half-octagon shape in top plan view.

15. The tree stand of claim 1, further comprising a base mounting member integral to or attached the platform for pivotally mounting the arm to the platform.

16. The tree stand of claim 15, wherein a surface of the base mounting member carries a plurality of serrations or teeth for gripping a tree trunk.

17. The tree stand of claim 16, further comprising a securement means engaged with the base member for securing the tree stand to the tree trunk, wherein the securement means is selected from the group consisting of a belt, band, harness, rope, ratchet strap, strap, and tie.

18. The tree stand of claim 11, wherein the low-profile arm comprises (a) a first arm portion having first and second ends, wherein the chair is rotatably mounted to the first end of the first arm portion of low-profile arm and the first arm portion extends downwardly from the seat of the chair at an angle of greater than 0 degrees and less than 90 degrees from an imaginary line extending vertically downwardly from the seat of the chair, and (b) a second arm portion having first and second ends, wherein the first end of the second arm portion is connected to the second end of the first arm portion to form a first obtuse angle facing toward the rear of the seat of the chair, and wherein the second arm portion of the low-profile arm extends horizontally relative to the top surface of the platform.

19. The tree stand of claim 1, further comprising a ladder attached to said platform.

20. The tree stand of claim 19, wherein the ladder comprises spaced-apart two elongated side rails and a plurality of rungs extending horizontally between the elongated side rails.
